(19) United States
(12) Patent Application Publication
(10) Pub. No.: US 2026/0067727 A1
(43) Pub. Date: Mar. 5, 2026

(54) METHODS AND SYSTEMS FOR HANDLING GAPS IN WIRELESS NETWORK

(71) Applicant: Samsung Electronics Co., Ltd., Suwon-si, Gyeonggi-do (KR)

(72) Inventors: Aby Kanneath ABRAHAM, Bangalore (IN); Vinay Kumar SHRIVASTAVA, Bangalore (IN); Sriganesh RAJENDRAN, Bangalore (IN)

(21) Appl. No.: 19/104,540

(22) PCT Filed: Aug. 16, 2023
(86) PCT No.: PCT/KR2023/012120

§ 371 Date: Feb. 18, 2025

(30) Foreign Application Priority Data
Aug. 17, 2022 (IN) 202241046670
Jul. 28, 2023 (IN) 202241046670

(51) Int. Cl. H04W 24/10; H04W 24/08

(52) U.S. Cl. CPC H04W 24/10; H04W 24/08

(57) ABSTRACT

The disclosure relates to a 5G or 6G communication system for supporting a higher data transmission rate. The present disclosure provides methods for handling a measurement gap in a wireless network (1000) by a network apparatus (200). The method includes receiving a message from a UE (100). The message includes at least one of a UE capability information indicating a capability of supporting a preconfigured gap and a concurrent gap together, a capability of supporting NCSG and a concurrent gap together, a capability of a supporting NCSG and a non-NCSG measurement gap together, whether the UE (100) is capable of supporting a preconfigured NCSG, and whether the UE (100) is capable of supporting the concurrent gap, the preconfigured gap, and the preconfigured NCSG together. Based on the received message, the method includes performing an action.

### TECHNICAL FIELD

The present invention relates to wireless communication networks, and more particularly to methods, a User Equipment (UE), and a network apparatus for handling one or more gaps in the wireless communication networks.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The present invention has been made to address at least the above problems and/or disadvantages and to provide at least the advantages described below. Accordingly, an aspect of the present invention provides methods and systems for handling gaps in wireless network.

The principal object of the embodiments herein is to disclose methods and systems for handling one or more gaps in a wireless communication networks (e.g., 5th Generation (5G) wireless communication networks).

Another object of the embodiments herein is to provide that the UE informs a network apparatus (e.g., gNB or the like) about a support of different measurement gap enhancements simultaneously through a UE capability signalling.

Another object of the embodiments herein is to provide that the network apparatus restricts some of gap characteristics, when the network apparatus determines or identifies that different measurement gap enhancement features are not supported by the UE simultaneously.

Another object of the embodiments herein is to provide that the network apparatus configures positioning measurement gaps when concurrent measurement gaps or preconfigured measurement gaps are already configured.

Another object of the embodiments herein is to handle capability signalling by the UE for the support of simultaneous configuration of concurrent gaps, preconfigured gaps, and NCSG.

Another object of the embodiments herein is to provide that a default value is applied to a gap which is configured without gap priority such that the applied default value can allow the configuration of a concurrent gap as a lower priority gap or a higher priority gap to the UE with respect to the gap configured without gap priority), when the UE is configured by the network apparatus with concurrent measurement gaps and one of the concurrent gaps is configured without priority. In the prior arts, default gap priority is the highest gap priority (gappriority=1), whereas the proposed method is set it to a value between 2 and 15, so that the concurrent gap can be configured as a higher priority gap.

Another object of the embodiments herein is to configure enhanced measurement gaps in dual connectivity in EN-DC and Ng-EN-DC.

Another object of the embodiments herein is to disclose implementation of enhanced measurement gaps in NR.

### Solution to Problem

Accordingly, the embodiments herein provide methods for handling a measurement gap in a wireless network. The method includes receiving, by a network apparatus, a message from a UE. The message includes at least one of a UE capability information indicating a capability of supporting a preconfigured gap and a concurrent gap together, a capability of supporting network controlled small gap (NCSG) and a concurrent gap together, a capability of a supporting NCSG and a non-NCSG measurement gap together, whether the UE is capable of supporting a preconfigured NCSG, and whether the UE is capable of supporting the concurrent gap, the preconfigured gap, and the preconfigured NCSG together. The method includes performing, by the network apparatus, at least one action based on the received message.

In an embodiment, performing, by the network apparatus, the at least one action during a configuration of the concurrent gap when the UE is already configured with the preconfigured gap and the UE does not support the preconfigured gap and the concurrent gaps together includes perform one of: modifying an already configured preconfigured gap to always active gap or releasing the already configured preconfigured gap and adding at least one always active gap.

In an embodiment, performing, by the network apparatus, the at least one action during a configuration of the concurrent gap when the UE is already configured with the NCG and the UE does not support the NCSG and the concurrent gaps together includes perform one of: modifying an already configured NCSG to a measurement gap or releasing the already configured NCG, and adding at least one measurement gap.

In an embodiment, performing, by the network apparatus, the at least one action includes receiving, by the network apparatus, gap and NCSG requirements through a needforgapNCSG from the UE, determining, by the network apparatus, a handover from the network apparatus to another network apparatus, converting, by the network apparatus, the needforGapNCSG to needforGaps upon determining that the another network apparatus does not support the needforgapnesg, and appending, by the network apparatus, the needforGaps in a handover request message.

In an embodiment, performing, by the network apparatus, the at least one action includes receiving, by the network apparatus, a needforGapNCSG from the UE, where the needforGapNCSG indicates that the UE supports a NCSG for a first set bands and gaps for a second set of bands, and releasing, by the network apparatus, the NCSG and configuring at least one gap for measuring both frequencies when the network apparatus decides to configure the UE with a mobile originated (MO) for a NR frequency, the UE needs gap for measurements and the UE does not support the NCSG and measurement gaps together as indicated through a UE capability information.

In an embodiment, performing, by the network apparatus, the at least one action includes one of allocating a per-UE gap upon receiving a location measurement indication to inform that the UE needs gaps, and the network apparatus has configured a per-FR1 gap or a per-FR2 gap and mapping the per-UE gap for location measurements, and releasing the per-UE gap after receiving location measurement indication for stopping measurements and re-associating any measurements objects associated on the per-UE gap to a per-FR gap.

Accordingly, the embodiments herein provide methods for handling a measurement gap in a wireless network. The method includes receiving, by a UE, a request for reporting a UE capability from a network apparatus. Further, the method includes sending, by the UE, a message to a network apparatus based on the received request. The message includes at least one of a UE capability information indicating a capability of supporting a preconfigured gap and a concurrent gap together, a capability of supporting NCSG and a concurrent gap together, a capability of a supporting NCSG and a non-NCSG measurement gap together, whether the UE is capable of supporting a preconfigured NCSG, and whether the UE is capable of supporting the concurrent gap, the preconfigured gap, and the preconfigured NCSG together.

Accordingly, the embodiments herein provide a network apparatus including a measurement gap controller coupled with a processor and a memory. The measurement gap controller is configured to receive a message from a UE. The message includes at least one of a UE capability information indicating a capability of supporting a preconfigured gap and a concurrent gap together, a capability of supporting NCSG and a concurrent gap together, a capability of a supporting NCSG and a non-NCSG measurement gap together, whether the UE is capable of supporting a preconfigured NCSG, and whether the UE is capable of supporting the concurrent gap, the preconfigured gap, and the preconfigured NCSG together. Further, the measurement gap controller is configured to perform at least one action based on the received message.

Accordingly, the embodiments herein provide a UE including a measurement gap controller coupled with a processor and a memory. The measurement gap controller is configured to receive a request for reporting a UE capability from a network apparatus. Further, the measurement gap controller is configured to send a message to a network apparatus based on the received request. The message includes at least one of a UE capability information indicating a capability of supporting a preconfigured gap and a concurrent gap together, a capability of supporting NCSG and a concurrent gap together, a capability of a supporting NCSG and a non-NCSG measurement gap together, whether the UE is capable of supporting a preconfigured NCSG, and whether the UE is capable of supporting the concurrent gap, the preconfigured gap, and the preconfigured NCSG together.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for methods and systems for handling gaps in wireless network.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates a wireless network for handling a measurement gap, according to embodiments as disclosed herein;

FIG. 2 shows various hardware components of a UE, according to the embodiments as disclosed herein;

FIG. 3 shows various hardware components of a network apparatus, according to the embodiments as disclosed herein;

FIG. 4 is a flow chart illustrating a method, implemented by the UE, for handling the measurement gap in the wireless network, according to embodiments as disclosed herein;

FIG. 5 is a flow chart illustrating a method, implemented by the network apparatus, for handling the measurement gap in the wireless network, according to embodiments as disclosed herein;

FIG. 6 is a flow chart illustrating an example method, implemented by the UE, for setting a default gap priority at the UE, according to embodiments as disclosed herein;

FIG. 7 is a flow chart illustrating an example method depicting the SN allocating measurement gaps when the MN/SN supports MGE in the wireless network, according to embodiments as disclosed herein;

FIG. 8 is a flow chart illustrating an example method, implemented by the network apparatus, for allocating multiple measurement gaps in the wireless network, according to embodiments as disclosed herein; and

FIG. 9 is a flow chart illustrating an example method, implemented by the network apparatus, for handling gap and NCSG capabilities in the wireless network, according to embodiments as disclosed herein.

### MODE FOR THE INVENTION

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

Embodiments herein disclose method for handling a measurement gap in a wireless network. The method includes receiving, by a network apparatus, a message from a UE. The message includes at least one of a UE capability information indicating a capability of supporting a preconfigured gap and a concurrent gap together, a capability of supporting NCSG and a concurrent gap together, a capability of a supporting NCSG and a non-NCSG measurement gap together, whether the UE is capable of supporting a preconfigured NCSG, and whether the UE is capable of supporting the concurrent gap, the preconfigured gap, and the preconfigured NCSG together. The method includes performing, by the network apparatus, an action based on the received message.

The proposed method can be used to enable a support of combination of measurement gap enhancement features, such as configuration of concurrent gaps with at least one of the concurrent gap is a preconfigure gap, preconfigured NCSG, concurrent gaps with at least one of the concurrent gap is NCSG. The proposed method allows the network apparatus to support the UEs which support multiple measurement gap features simultaneously as well as the UEs which support measurement gap features individually, but not simultaneously.

In wireless technologies like new radio (NR) and Long Term Evolution (LTE), a radio resource control (RRC) connected UE performs various measurements for Radio resource management (RRM) purpose, positioning etc. For the RRM, the UE measures reference signals such as synchronization signal block (SSB), Channel State Information Reference Signal (CSI-RS) etc. and the UE reports the measurements to a network apparatus.

According to the NR specification technical specification (TS) 38.300, measurements to be performed by the UE for connected mode mobility are classified in at least four measurement types:
1. Intra-frequency NR measurements,
2. Inter-frequency NR measurements,
3. Inter-RAT measurements for Evolved Universal Terrestrial Radio Access (E-UTRA), and
4. Inter-RAT measurements for UTRA.

For each measurement type, one or several measurement objects can be defined (a measurement object defines a carrier frequency (for example) to be monitored). For each measurement object, one or several reporting configurations can be defined (a reporting configuration defines a reporting criteria). In an example, three reporting criteria can be used: event triggered reporting, periodic reporting and event triggered periodic reporting. The association between a measurement object and a reporting configuration is created by a measurement identity (a measurement identity links together one measurement object and one reporting configuration of the same RAT). The measurement identity is used as well when reporting results of the measurements.

For positioning, the UE may report SSB/CSI-RS measurements and may also report measurements based on additional reference signals such as, but not limited to, positioning reference signals (PRS).

When the UE needs to measure inter frequency NR or inter-RAT measurements or intra frequency measurements outside an active downlink Bandwidth Part (BWP) when the SSB is not completely contained in the active DL BWP, the UE may use measurement gaps. The measurement gaps are configured by the network apparatus (e.g., gNB or the like) in NR) and there will not be any transmission or reception during a gap period. Measurement gap configuration includes a gap offset, gap length, repetition period and measurement gap timing advance. The gap offset specifies a subframe where the measurement gap occurs. The gap length gives the duration of the gap while the repetition period defines how often the measurement gap can occur.

3GPP has defined a number of measurement gap patterns, where each gap pattern corresponds to a gap length and a gap repetition period. For example, in NR release 16, there are 26 gap patterns defined. Measurement gap timing advance (mgta) specifies a timing advance value in ms. Gap occurs mgta milliseconds before the subframe given by the measurement gap offset.

Till release 16 of NR specifications, the UE may be configured with maximum one measurement gap at any time. The measurement gaps are activated immediately after the configuration, from a measurement gaps offset that comes after the reconfiguration. This leads to restrictions for the UE and network apparatus implementation.

In NR Release 17, the network apparatus may configure the UE with concurrent measurement gaps (also known as concurrent gaps or multiple measurement gap) as shown in Table 1.

TABLE 1

| Gap | The number of simultaneous configured | | |
|---|---|---|---|
| Combination | measurement gap patterns | | |
| Configuration | Per-FR1 | Per-FR2 | Per-UE |
| Id | measurement gap | measurement gap | measurement gap |
| 0 | 2 | 1 | 0 |
| 1 | 1 | 2 | 0 |
| 2 | 0 | 0 | 2 |
| 3 (Note 1) | 1 | 0 | 1 |
| 4 (Note 1) | 0 | 1 | 1 |
| 5 (Note 1) | 1 | 1 | 1 |

(Note 1):
Gap Combination Configuration Id #3, #4, #5 will be only applied when the per-UE measurement gap is associated to measure PRS for any RSTD, PRS-RSRP, and UE Rx-Tx time difference measurement defined in TS 38.215.

As can be seen from the table 1 above, the concurrent gap may include 2 per-FR gaps of same type (per-FR1/per-FR2) and 1 per-FR gap of another type. The concurrent gap also may include 1 per-UE gap along with 1 per-FR1 gap or 1 per-FR2 gap or 1 each of per-FR1 gap and 1 per-FR2 gap.

Each measurement gap could be associated with one or multiple frequency layers, while each frequency layer can be associated with only one of the concurrent gaps. Each measured Synchronization Signal Block (SSB) or Long Term Evolution (LTE) frequency is considered as one frequency layer. The SSB and the CSI-RS measurement in one measurement object (MO) are considered as different frequency layers. One of the measurement gaps can also be associated with positioning reference signal (PRS); i.e., PRS also is considered as a frequency layer. In other words, each E-UTRA MO, or PRS is a frequency layer, while the NR MO may contain one or two frequency layers depending on whether it contains either of SSB and CSI-RS or both of them. NR Release 17 also supports preconfigured measurement gaps (gaps that may be activated or deactivated based on some actions like a bandwidth part switch or SCell addition or SCell Release or SCG addition or SCG Release) and network controlled small gaps (NCSG). Multiple measurement gaps, preconfigured measurement gaps and network controlled small gaps (NCSG-small gaps which are also called interruptions) can be referred together as measurement gap enhancements.

Types of gaps: Till Release 16 of 3GPP specifications, the gaps were only used for measurements (intra frequency/inter frequency/inter RAT/positioning etc.). In release 17 of 3GPP, new types of gaps are introduced. Below are listed a few example gaps.
1. Multi SIM (MUSIM) gaps: MUSIM UEs support multiple USIMs within a same device. A RRC connected MUSIM USIM can request its network to allocate the gaps during its connected mode operations for performing idle/inactive mode operations in other USIMs. In Release 17 of 3GPP specification, the UE can request up to 3 periodic MUSIM gaps and one aperiodic MUSIM gap.
2. Non Terrestrial Network (NTN) gaps: In release 17, 3GPP introduced enhancements for measurement gaps for Non Terrestrial Network operations. These gaps are mainly used for monitoring configured SSB-based RRM Measurement Timing Configuration (SMTC) in NTN.
3. Enhanced Positioning (cPOS) gaps: 3GPP introduced support for enhanced positioning gaps in Release 17. These gaps are used exclusively for positioning measurements and can be preconfigured and activated or deactivated based on layer 2 MAC (Medium Access Control) signaling.
4. FR2UL gaps: 3GPP also introduced uplink only gaps in FrequencyRange2 (FR2) in release 17. Upon configuration, these gaps are mainly used for body proximity sensing (BPS) measurements. FR2UL gaps are applicable only for FR2 and will use only uplink slots; i.e., downlink and special slots of time division duplexing are available for transmission or reception.

Gap Priority: Each of the measurement gaps can be configured with a gap priority to resolve collisions between measurement gap occasions through RRC signaling. In each collision, the UE will perform only measurements associated with the measurement gap with the highest priority and will drop the measurements associated with lower priority. In the release 17 version of 3GPP specifications, only the measurement gaps are associated with priority (i.e., there is no gap priority for MUSIM gaps, NTN gaps, cPOS gaps, FR2-UL gaps), and there is no equal priority between gaps. Range of priorities is 1 to 16. The network apparatus (e.g., gNB or the like) may configure the UE with either a per-UE measurement gap or a per-FR1 measurement gap and/or a per-FR2 measurement gap without providing priority. All other measurement gaps are configured with a priority value. In the known prior arts, the UE apply a default value equal to the highest gap priority possible as the gap priority (gap priority=1) when the network apparatus configures a measurement gap without priority.

Dual Connectivity: Dual connectivity or more technically multi-radio dual connectivity is specified by the 3GPP in specifications such as TS 37.340. A summary of the details on dual connectivity and measurement gap operations with dual connectivity are given below.

The NG-RAN supports Multi-Radio Dual Connectivity (MR-DC) operation whereby the UE in the RRC_CONNECTED is configured to utilize radio resources provided by two distinct schedulers, located in two different NG-RAN nodes connected via a nonideal backhaul, one providing NR (New Radio) access and the other one providing either E-UTRA (Evolved UMTS Terrestrial Radio Access) or NR access. One node acts as the master node (MN) and the other as the secondary node (SN). The MN and the SN are connected via a network interface and at least the MN is connected to a core network. The NG-RAN supports NG-RAN E-UTRA-NR Dual Connectivity (NGEN-DC), in which the UE is connected to the ng-eNB (a E-UTRA base station that can connect to the 5G core) that acts as a MN and one network apparatus (5G base station) that acts as a SN. The NG-RAN also supports NR-E-UTRA Dual Connectivity (NE-DC), in which the UE is connected to one network apparatus that acts as a MN and one ng-cNB that acts as a SN.

Measurement Gaps with Dual Connectivity: Per-UE or per-FR measurement gaps can be configured, depending on UE capability to support independent FRmeasurement and network preference. The Per-UE gap applies to both FR1 (E-UTRA, UTRA-FDD and NR) and FR2 (NR) frequencies. For per-FR gap, two independent gap patterns (i.e., FR1 gap and FR2 gap) are configured for FR1 and FR2 respectively. The UE may also be configured with a per-UE gap sharing configuration (applying to per-UE gap) or with two separate gap sharing configurations (applying to FR1 and FR2 measurement gaps respectively).

A measurement gap configuration is always provided:
1. In EN-DC, NGEN-DC and NE-DC, for UEs configured with E-UTRA inter-frequency measurements.
2. In EN-DC and NGEN-DC, for UEs configured with UTRAN and GERAN.
3. In NR-DC, for UEs configured with E-UTRAN measurements.
4. In NR-DC, NE-DC, for UEs configured with UTRAN measurements.
5. In MR-DC, for UEs that support either per-UE or per-FR gaps, when the conditions to measure SSB based inter-frequency measurement or SSB based intra-frequency measurement as described in TS 38.300 are met.

If a per-UE gap is used, the MN decides the gap pattern and the related gap sharing configuration. If a per-FR gap is used, in EN-DC and NGEN-DC, the MN decides the FR1 gap pattern and the related gap sharing configuration for FR1, while the SN decides the FR2 gap pattern and the related gap sharing configuration for the FR2; in NE-DC and NR-DC, the MN decides both the FR1 and FR2 gap patterns and the related gap sharing configurations. In EN-DC and NGEN-DC, the measurement gap configuration from the MN to the UE indicates if the configuration from the MN is a per-UE gap or an FR1 gap configuration. The MN also indicates the configured per-UE or FR1 measurement gap pattern and the gap purpose (per-UE or per-FR1) to the SN. But in any of the prior arts, SN doesn't communicate the per-FR2 gaps it has configured to MN.

Measurement gap configuration assistance information can be exchanged between the MN and the SN. For the case of the per-UE gap, the SN indicates to the MN the list of SN configured frequencies in FR1 and FR2 measured by the UE. For the per-FR gap case, the SN indicates to the MN the list of SN configured frequencies in FR1 measured by the UE and the MN indicates to the SN the list of MN configured frequencies in FR2 measured by the UE. In NE-DC, the MN indicates the configured per-UE or FR1 measurement gap pattern to the SN. The SN can provide a gap request to the MN, without indicating any list of frequencies. In NR-DC, the MN indicates the configured per-UE, FR1 or FR2 measurement gap pattern and the gap purpose to the SN. The SN can indicate to the MN the list of SN configured frequencies in FR1 and FR2 measured by the UE.

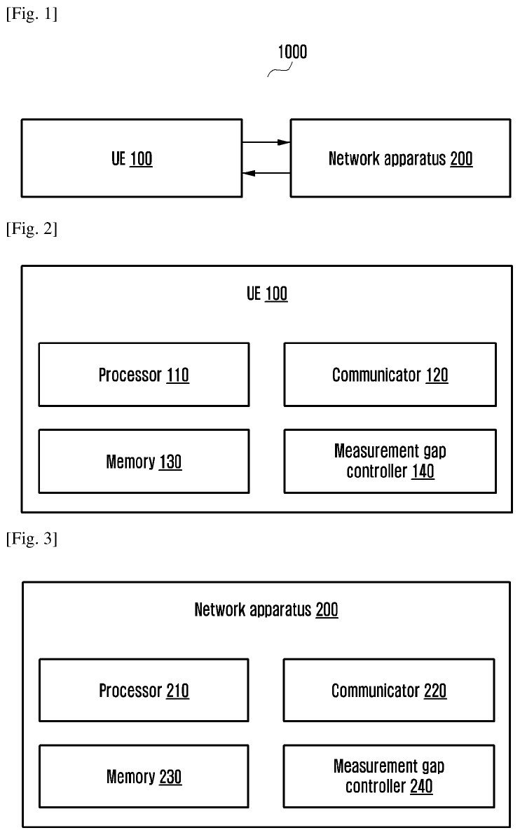

Referring now to the drawings, and more particularly to FIGS. 1 through 9, where similar reference characters denote corresponding features consistently throughout the figures, there are shown at least one embodiment.

FIG. 1 illustrates a wireless network (1000) for handling a measurement gap, according to embodiments as disclosed herein. The wireless network (1000) can be, for example, but not limited to a fourth generation (4G) network, a fifth generation (5G) network, a sixth generation (6G) network, an Open Radio Access Network (ORAN) or the like.

In an embodiment, the wireless network (1000) includes a UE (100) and a network apparatus (200). The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network apparatus (200) can be, for example, but not limited to a gNB, a eNB, a new radio (NR) trans-receiver or the like.

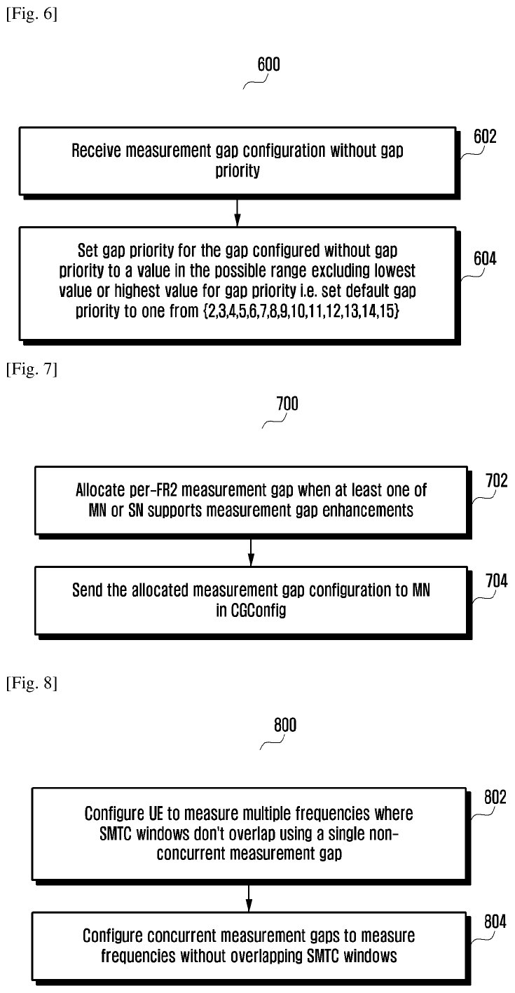

In an embodiment, the UE (100) which has received measurement gap configuration from the network apparatus (e.g., gNB or the like) (200) without a gap priority provided, assigns a gap priority within the range of the allowed gap priorities and which is not highest gap priority (upper bound, i.e., 1 in NR R17) or lowest gap priority (lower bound. i.e., 16 in NR R17). When the possible range is from 1 to 16, the UE (100) assigns a gap priority from 2 to 15, and the UE (100) doesn't assign the gap priority 1 or gap priority 16. That is, the UE (100) sets the default gap priority from {2,3,4,5,6,7,8,9,10,11,12,13,14,15}. FIG. 6 depicts the process of setting the default gap priority at the UE (100). In an example, the assigned default gap priority according to above embodiment is 2. In an example, the assigned default gap priority according to above embodiment is 8.

In an embodiment, the set of default gap priority/priorities can be a sub-set of gap priority set and comprising of N elements, where N can be at least one of network configured value or a pre-specified value or a UE determined value. Continuing the above example, 1<N<=15. In an example, the network apparatus (200) may inform the value of N as 10 to the UE (100) in the RRC message. If the UE (100) receives the value then, the UE (100) uses 10 as the value of N. If the UE (100) doesn't receive value N from the network apparatus (200), the UE (100) may use the default value, for e.g., 1.

A set of sample changes in TS 38.331 according to the embodiments is given below:
1. MeasGapConfig: The IE MeasGapConfig specifies the measurement gap configuration and controls setup/release of measurement gaps.
   1. In an example, A MeasGapConfig information element is depicted below:

-- ASN1START
-- TAG-MEASGAPCONFIG-START

| MeasGapConfig ::= | SEQUENCE { | |
|---|---|---|
| gapFR2 | SetupRelease { GapConfig } | OPTIONAL, |

```
-- Need M
  ...,
  [[
```

| | | |
|---|---|---|
| gapFR1 | SetupRelease { GapConfig } | OPTIONAL, |

-- Need M

| | | |
|---|---|---|
| gapUE | SetupRelease { GapConfig } | OPTIONAL |

```
-- Need M
  ]],
  [[
```

| | |
|---|---|
| gapToAddModList-r17 | SEQUENCE (SIZE (1..maxNrofGapId-r17)) |
| | OF GapConfig- |

r17 OPTIONAL, -- Need N

| | |
|---|---|
| gapToReleaseList-r17 | SEQUENCE (SIZE (1..maxNrofGapId-r17)) |
| | OF MeasGapId- |

r17 OPTIONAL, -- Need N

| | |
|---|---|
| posMeasGapPreConfigToAddModList-r17 | PosMeasGapPreConfigToAddModList-r17 |

OPTIONAL, -- Need N

| | |
|---|---|
| posMeasGapPreConfigToReleaseList-r17 | PosMeasGapPreConfigToReleaseList-r17 |

OPTIONAL -- Need N
]]
}

| | |
|---|---|
| GapConfig ::= | SEQUENCE { |
| gapOffset | INTEGER (0..159), |
| mgl | ENUMERATED {ms1dot5, ms3, ms3dot5, ms4, ms5dot5, ms6}, |
| mgrp | ENUMERATED {ms20, ms40, ms80, ms160}, |
| mgta | ENUMERATED {ms0, ms0dot25, ms0dot5}, |

```
  ...
  [[
```

| | |
|---|---|
| refServCellIndicator | ENUMERATED {pCell, pSCell, mcg-FR2} |

```
OPTIONAL -- Cond NEDCorNRDC
  ]],
  [[
```

| | | |
|---|---|---|
| refFR2ServCellAsyncCA-r16 | ServCellIndex | OPTIONAL, |

-- Cond AsyncCA

| | | |
|---|---|---|
| mgl-r16 | ENUMERATED {ms10, ms20} | OPTIONAL |

-- Cond PRS
]]
}

| | |
|---|---|
| GapConfig-r17 ::= | SEQUENCE { |
| measGapId-r17 | , |
| gapType-r17 | ENUMERATED {perUE, perFR1, perFR2}, |
| gapOffset-r17 | INTEGER (0..159), |
| mgl-r17 | ENUMERATED {ms1, ms1dot5, ms2, ms3, ms3dot5, ms4, ms5, |

ms5dot5, ms6, ms10, ms20},

| | |
|---|---|
| mgrp-r17 | ENUMERATED {ms20, ms40, ms80, ms160}, |
| mgta-r17 | ENUMERATED {ms0, ms0dot25, ms0dot5, ms0dot75}, |

| | |
|---|---|
| refServCellIndicator-r17 | ENUMERATED {pCell, pSCell, mcg-FR2} |

OPTIONAL, -- Cond NEDCorNRDC

| | | |
|---|---|---|
| refFR2-ServCellAsyncCA-r17 | ServCellIndex | OPTIONAL, |

-- Cond AsyncCA

| | | |
|---|---|---|
| preConfigInd-r17 | ENUMERATED {true} | OPTIONAL, |

-- Need R

| | | |
|---|---|---|
| ncsgInd-r17 | ENUMERATED {true} | OPTIONAL, |

-- Need R

| | |
|---|---|
| gapAssociationPRS-r17 | ENUMERATED {true} |

OPTIONAL, -- Need R

| | | |
|---|---|---|
| gapSharing-r17 | MeasGapSharingScheme | OPTIONAL, |

-- Need R

| | | |
|---|---|---|
| gapPriority-r17 | GapPriority-r17 | OPTIONAL, |

-- Need R
...
}

| | | |
|---|---|---|
| PosMeasGapPreConfigToAddModList-r17 | ::= | SEQUENCE (SIZE |

(1..maxNrofPreConfigPosGapId-r17))
OF PosGapConfig-r17

| | | |
|---|---|---|
| PosMeasGapPreConfigToReleaseList-r17 | ::= | SEQUENCE (SIZE |

(1..maxNrofPreConfigPosGapId-r17))
OF MeasPosPreConfigGapId-r17

| | |
|---|---|
| PosGapConfig-r17 ::= | SEQUENCE { |
| measPosPreConfigGapId-r17 | MeasPosPreConfigGapId-r17, |
| gapOffset-r17 | INTEGER (0..159), |
| mgl-r17 | ENUMERATED {ms1dot5, ms3, ms3dot5, ms4, ms5dot5, ms6, |
| ms10, ms20}, | |
| mgrp-r17 | ENUMERATED {ms20, ms40, ms80, ms160}, |
| mgta-r17 | ENUMERATED {ms0, ms0dot25, ms0dot5}, |
| gapType-r17 | ENUMERATED {perUE, perFR1, perFR2}, |

...
}
MeasPosPreConfigGapId-r17 ::= INTEGER (1..maxNrofPreConfigPosGapId-r17)
-- TAG-MEASGAPCONFIG-STOP
-- ASN1STOP

MeasGapConfig field descriptions

gapAssociationPRS
Indicates that PRS measurement is associated with this measurement gap. The network only includes
this field for one per UE gap. If concurrent gap (i.e., one of the gap combination as defined in Table
9.1.8-1 in TS 38.133) is configured and no gap is configured with this field, the PRS measurement
is associated with the gap configured via gapUE, if available.
gapFR1
Indicates measurement gap configuration that applies to FR1 only. In (NG)EN-DC, gapFR1 cannot
be set up by NR RRC (i.e., only LTE RRC can configure FR1 measurement gap). In NE-DC,
gapFR1 can only be set up by NR RRC (i.e., LTE RRC cannot configure FR1 gap). In NR-DC,
gapFR1 can only be set up in the measConfig associated with MCG. gapFR1 cannot be configured
together with gapUE. The applicability of the FR1 measurement gap is according to Table 9.1.2-2
and Table 9.1.2-3 in TS 38.133. If more than one measurement gap is configured (i.e., concurrent
measurement gap as specified in TS 38.133, clause 9.1.8) using this field, the measurement gap
priority of gapFR1 is defined as value 2.
gapFR2
Indicates measurement gap configuration applies to FR2 only. In (NG)EN-DC or NE-DC, gapFR2
can only be set up by NR RRC (i.e., LTE RRC cannot configure FR2 gap). In NR-DC, gapFR2 can
only be set up in the measConfig associated with MCG. gapFR2 cannot be configured together with
gapUE. The applicability of the FR2 measurement gap is according to Table 9.1.2-2 and Table 9.1.2-
3 in TS 38.133. If more than one measurement gap is configured (i.e., concurrent measurement gap
as specified in TS 38.133, clause 9.1.8) using this field, the measurement gap priority of gapFR2 is
defined as value 2.
gapOffset
Value gapOffs
et is the gap offset of the gap pattern with MGRP indicated in the field mgrp. The value range is
from 0 to mgrp-1. If ncsgInd-r17 is present, this offset value refers to the starting point of VIL1 (the
visible interruption length before the ML).
gapPriority
Indicates the priority of this measurement gap (see TS 38.133, clause FFS). Value 1 indicates highest
priority, value 2 indicates second level priority, and so on.
gapSharing
Indicates the measurement gap sharing scheme that applies to this GapConfig. For applicability of
the different gap sharing schemes, see TS 38.133. Value scheme00 corresponds to scheme “00”,
value scheme01 corresponds to scheme “01”, and so on.
gapToAddModList
A list of measurement gap configuration to be added or modified. If more than one measurement
gap is configured (i.e., concurrent measurement gap as specified in TS 38.133, clause 9.1.8), the
maximum number of configured measurement gap is limited by the gap combinations defined in
Table 9.1.8-1 in TS 38.133. The network configures at most one NCSG or pre-configured
measurement gap for a given gap type. In this version of the specification, the network configures
this field only in NR standalone.
gapToReleaseList
A list of measurement gap configuration to be released.
gapType
Indicates the type of this measurement gap. Value perUE indicates that it is a per UE measurement
gap, value perFR1 indicates that it is an FR1 measurement gap, and value perFR2 indicates that it
is an FR2 measurement gap.
gapUE
Indicates measurement gap configuration that applies to all frequencies (FR1 and FR2). In (NG)EN-
DC, gapUE cannot be set up by NR RRC (i.e., only LTE RRC can configure per UE measurement
gap). In NE-DC, gapUE can only be set up by NR RRC (i.e., LTE RRC cannot configure per UE
gap). In NR-DC, gapUE can only be set up in the measConfig associated with MCG. If gapUE is
configured, then neither gapFR1 nor gapFR2 can be configured. The applicability of the per UE
measurement gap is according to Table 9.1.2-2 and Table 9.1.2-3 in TS 38.133. If more than one
measurement gap is configured (i.e., concurrent measurement gap as specified in TS 38.133, clause
9.1.8) using this field, the measurement gap priority of gapUE is defined as value 2.
measGapId
The ID of this measurement gap configuration.
mgl
Value mgl is the measurement gap length in ms of the measurement gap. If ncsgInd-r17 is not
present, the measurement gap length is according to in Table 9.1.2-1 in TS 38.133. If ncsgInd-r17
is present, this field indicates the measurement length (ML) in NCSG pattern and is configured
according to Table 9.1.2C-1 in TS 38.133. Value ms1dot5 corresponds to 1.5 ms, ms3 corresponds
to 3 ms and so on. If mgl-r16 is present, UE shall ignore the mgl (without suffix). Value ms1, ms2,
and ms5 can only be configured if ncsgInd is present.
mgrp
Value mgrp is measurement gap repetition period in (ms) of the measurement gap. The measurement
gap repetition period is according to Table 9.1.2-1 in TS 38.133.
mgta
Value mgta is the measurement gap timing advance in ms. The applicability of the measurement gap
timing advance is according to clause 9.1.2 of TS 38.133. Value ms0 corresponds to 0 ms, ms0dot25
corresponds to 0.25 ms and ms0dot5 corresponds to 0.5 ms. For FR2, the network only configures
0 ms and 0.25 ms. If ncsgInd is present, value ms0dot25 cannot be configured. Value ms0dot75 can
only be configured if ncsgInd is present.
ncsgInd
Indicates that the measurement gap is a NCSG as specified in 38.133.
posMeasGapPreConfigToAddModList
List of preconfigured measurement gap for positioning to add and/or modify. All the gaps configured
are associated with the measurement of PRS for RSTD, UE-RxTx Time Difference, PRS-RSRP and
PRS-RSRPP as defined in TS 38.215.
posMeasGapPreConfigToReleasList
List of preconfigured measurement gap for positioning to release.
preConfigInd
Indicates whether the measurement gap is a pre-configured measurement gap.
refFR2ServCellAsyncCA
Indicates the FR2 serving cell identifier whose SFN and subframe is used for FR2 gap calculation
for this gap pattern with asynchronous CA involving FR2 carrier(s).
refServCellIndicator
Indicates the serving cell whose SFN and subframe are used for gap calculation for this gap pattern.
Value pCell corresponds to the PCell, pSCell corresponds to the PSCell, and mcg-FR2 corresponds
to a serving cell on FR2 frequency in MCG.

Case 1: When the UE applies the gap priority as lowest gap priority for gaps configured without priority (default gap priority=15); In an embodiment, the network apparatus (e.g., gNB or the like) (200) which has configured the UE (100) with the measurement gap (gap1) without the gap priority while configuring a concurrent measurement gap, i.e., a new measurement gap (gap2) with a lower priority or any other gap with lower priority, releases the previously added measurement gap (gap1) without a gap priority and configures at least two new measurement gaps (gap1 and gap2) with a gap priority.

Case 2: When the UE (100) applies gap priority as highest gap priority for gaps configured without priority (default gap priority=1); In an embodiment, the network apparatus (e.g., gNB or the like) (200) which has configured the UE (100) with the measurement gap (gap1) without the gap priority while configuring the concurrent measurement gap, i.e., a new measurement gap (gap2) with the higher priority or any other gap with higher priority, releases the previously added measurement gap (gap1) without gap priority and configures at least two new measurement gaps (gap1 and gap2) with gap priority.

Case 3: When the UE (100) applies gap priority as a value between lower bound and upper bound for gaps configured without priority (e.g., default gap priority=2 or default gap priority=8); In an embodiment, the network apparatus (e.g., gNB or the like) (200) which has configured the UE (100) with a measurement gap (gap1) without a gap priority while configuring a concurrent measurement gap, i.e., a new gap (gap2) with a lower priority or any other gap with lower priority, configures the new gap (gap2) with a lower gap priority and doesn't release the measurement gap configured without gap priority.

In an embodiment, when the network apparatus (e.g., gNB or the like) (200) configures the UE (100) with another new gap with a lower priority, gap3 (e.g., a gap including at least one of measurement gaps or MUSIM gap or FR2UL gaps), releases the previously configured measurement gap without gap priority (gap1) and adds at least two new gaps (gap1 and gap3).

EN-DC/Ng-EN-DC measurement gap enhancements: In an embodiment, in the ENDC/Ng-EN-DC (as depicted in FIG. 7), the SN allocates the FR2 measurement gaps (per-FR2 measurement gaps) with the measurement gap enhancements i.e., the SN allocates concurrent measurement gaps, preconfigured gaps or NCSG for FR2 measurement gaps.

In an embodiment, the SN sends the per-FR2 measurement gaps allocated with the measurement gap enhancements to the MN. The MN decides to allocate the measurement gaps with measurement gap enhancements (per-UE/per-FR1 gaps) according to the received information from SN.

In an embodiment, the SN sends the per-FR2 measurement gaps allocated with the measurement gap enhancements to the MN in Inter-Node Message (INM) RRC message CGConfig.

An example is given below:

| | |
|---|---|
| MeasConfigSN ::= | SEQUENCE { |

| | |
|---|---|
| measuredFrequenciesSN | SEQUENCE (SIZE (1..maxMeasFreqsSN)) OF NR- |

FreqInfo OPTIONAL,

| | | |
|---|---|---|
| measGapConfig-r17 | MeasGapConfig | OPTIONAL, |

...
}

Other aspects for Measurement gap enhancements implementation:

Configuration of concurrent measurement gaps: If the UE (100) which supports concurrent measurement gaps needs to measure NR frequencies which are having SMTC window (SSB-based RRM Measurement Timing Configuration window) not aligned to the SMTC window(s) of the serving frequency or already configured NR inter-frequency carriers, the network apparatus (e.g., gNB or the like) (200) configures concurrent measurement gaps (as depicted in FIG. 8).

In an embodiment, the UE (100) will inform the network apparatus (e.g., gNB or the like) (200) whether the UE (100) is capable of supporting preconfigured gap and concurrent gaps together in a RRC message like UE capability information, for e.g. using a single (optional) bit. For example, in the NR, the network apparatus (200) sends the RRC message UECapabilityEnquiry to retrieve the capabilities and the UE (100) may send the capability of supporting preconfigured gap and concurrent gaps together in the RRC message UECapabilityInformation. As described in the background, the concurrent gaps correspond to one of the gap combination configuration ids 0, 1, 2, 3, 4, 5. When the concurrent gaps and the preconfigured gaps are supported together at least one of the gaps in the gap combination configuration can be configured as the preconfigured gap based on the decision of network apparatus (200). In an example, there could be two per-FR1 measurement gaps and 1 per-FR2 measurement gaps configured together as in gap combination configuration id 0, and when the UE (100) supports the concurrent gaps and preconfigured gaps together, at least one of these 2 per-FR1 measurement gaps and 1 per-FR2 measurement gaps could be configured as a preconfigured gap by the network apparatus (100). Similarly, there could be two per-FR2 measurement gaps and 1 per-FR1 measurement gap configured together as in gap combination configuration id 1, and when the UE (100) supports concurrent gaps and preconfigured gaps together, at least one of these 2 per-FR2 measurement gaps and 1 per-FR1 measurement gaps could be configured as a preconfigured gap by the network apparatus (200). In yet another example, there could be two per-UE measurement gaps gap configured together as in gap combination configuration id 2, and when the UE (100) supports concurrent gaps and preconfigured gaps together, at least one of these 2 per-UE measurement gaps could be configured as a preconfigured gap by the network apparatus (200). Similarly, there could be one per-FR1 measurement gap and 1 per-UE measurement gap configured together as in gap combination configuration id 3, and when the UE (100) supports the concurrent gaps and the preconfigured gaps together, at least one of these 1 per-FR1 measurement gaps and 1 per-UE measurement gaps could be configured as a preconfigured gap by the network apparatus (200). There could be one per-FR2 measurement gap and 1 per-UE measurement gap configured together as in gap combination configuration id 4, and when the UE (100) supports the concurrent gaps and the preconfigured gaps together, at least one of these 1 per-FR2 measurement gaps and 1 per-UE measurement gaps could be configured as a preconfigured gap by the network apparatus (200). There could be one per-FR1 measurement gap, 1 per-FR2 measurement gap and 1 per-UE measurement gap configured together in gap combination configuration id 5, and when the UE (100) supports the concurrent gaps and the preconfigured gaps together, at least one of these 1 per-FR1 measurement gap, 1 per-FR2 measurement gap and 1 per-UE measurement gap could be configured as a preconfigured gap by the network apparatus (200). Thus, the network apparatus (200) configures any gap as a preconfigured gap within concurrent gaps based on the supported UE capability as reported by the UE (100) in the embodiment.

In an embodiment, the UE (100) will inform the network apparatus (200) whether it is capable of supporting NCSG and concurrent gaps together in a RRC message like UE capability information, for e.g. using a single (optional) bit. For example, in the NR, the network apparatus (200) sends the RRC message UECapabilityEnquiry to retrieve the capabilities and the UE (100) may send the capability of supporting NCSG and concurrent gaps together in the RRC message UECapability Information. As described in the background, the concurrent gaps correspond to one of the gap combination configuration ids 0, 1, 2, 3, 4, 5. When the concurrent gaps and the NCSG are supported together, at least one of the gaps in the gap combination configuration can be configured as NCSG based on the decision of the network apparatus (200). In an example, there could be two per-FR1 measurement gaps and 1 per-FR2 measurement gaps configured together as in gap combination configuration id 0, and when the UE (100) supports the concurrent gaps and the NCSG together, at least one of these 2 per-FR1 measurement gaps and 1 per-FR2 measurement gaps could be configured as NCSG by the network apparatus (200). Similarly, there could be two per-FR2 measurement gaps and 1 per-FR1 measurement gap configured together as in gap combination configuration id 1, and when the UE (100) supports concurrent gaps and NCSG together, at least one of these 2 per-FR2 measurement gaps and 1 per-FR1 measurement gaps could be configured as NCSG by the network apparatus (200). In yet another example, there could be two per-UE measurement gaps gap configured together as in gap combination configuration id 2, and when the UE (100) supports the concurrent gaps and the NCSG together, at least one of these 2 per-UE measurement gaps could be configured as NCSG by the network apparatus (200). Similarly, there could be one per-FR1 measurement gap and 1 per-UE measurement gap configured together as in gap combination configuration id 3, and when the UE (100) supports the concurrent gaps and the NCSG together, at least one of these 1 per-FR1 measurement gaps and 1 per-UE measurement gaps could be configured as the NCSG by the network apparatus (200). There could be one per-FR2 measurement gap and 1 per-UE measurement gap configured together as in the gap combination configuration id 4, and when the UE (100) supports the concurrent gaps and the NCSG together, at least one of these 1 per-FR2 measurement gaps and 1 per-UE measurement gaps could be configured as NCSG by the network apparatus (200). There could be one per-FR1 measurement gap, 1 per-FR2 measurement gap and 1 per-UE measurement gap configured together in the gap combination configuration id 5, and when the UE (100) supports the concurrent gaps and the NCSG together, at least one of these 1 per-FR1 measurement gap, 1 per-FR2 measurement gap and 1 per-UE measurement gap could be configured as a NCSG by the network apparatus (200). Thus, network apparatus (200) configures any gap as a NCSG within concurrent gaps based on the supported UE capability as reported by the UE (100) in the embodiment.

In an embodiment, the UE (100) will inform the network apparatus (200) whether the UE (100) is capable of supporting NCSG and (non-NCSG) measurement gaps together in a RRC message like UE capability information, for e.g. using a single (optional) bit. If the UE (100) informs the network apparatus (200) that the UE (100) is capable of supporting NCSG and measurement gaps together, the network apparatus (200) could configure the UE (100) with 2 gaps simultaneously, one a measurement gap and another one NCSG. In an example, the network apparatus (200) may configure one per-FR1 measurement gap and one per-FR2 NCSG together.

In an embodiment, the UE (100) will inform the network apparatus (200) whether the UE (100) is capable of supporting preconfigured NCSG in the RRC message like UE capability information, for e.g. using a single (optional) bit. If the UE (100) informs the network apparatus (200) that the UE (100) is capable of supporting preconfigured NCSG, the network apparatus (200) could configure the UE (100) a NCSG as preconfigured NCSG. For example, the network apparatus (200) may configure a gap with both the fields' preConfigInd-r17 and nesgInd-r17 as true in the gap configuration.

In an embodiment, the UE (100) will inform the network apparatus (200) whether the UE (100) supports concurrent gaps, preconfigured gaps, preconfigured NCSG all together using a single capability in a RRC message like UE capability information, for e.g. using a single (optional) bit.

Absence of the above capabilities, when it is optional, means that UE (100) doesn't support the said capability.

In an embodiment, the network apparatus (200) decides one or more of whether the UE (100) supports one or more of preconfigured gaps and concurrent gaps together, NCSG and concurrent gaps together, NCSG and (non-NCSG) measurement gaps together, preconfigured NCSG or concurrent gaps, preconfigured gaps, preconfigured NCSG all together based on the 3gpp NR release supported by the UE (100).

If the UE (100) is already configured with a preconfigured gap and the UE (100) doesn't support preconfigured gap and concurrent gaps together as indicated through the UE capability or the 3gpp release supported by the UE (100), when the network apparatus (200) decides to configure concurrent gaps, the network apparatus (200) modifies the already configured preconfigured gap to always active gap and adds one or more always active gaps. Alternatively, the network apparatus (200) may release the already configured preconfigured gap and add two or more always active gaps.

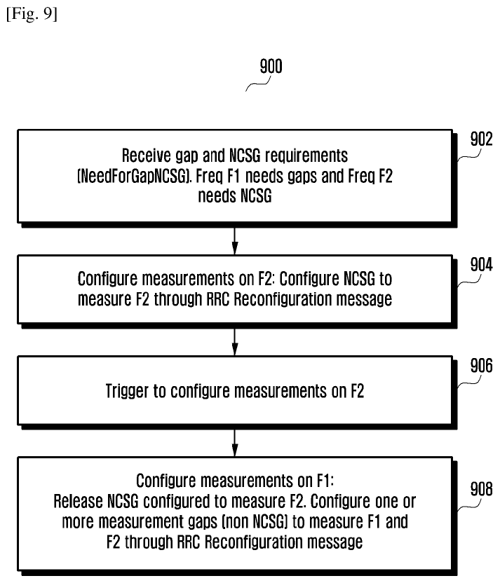

If the UE (100) is configured with concurrent gaps and the UE (100) doesn't support preconfigured gap/NCSG and concurrent gaps together as indicated through the UE capability or the 3gpp release supported by the UE (100) when the network apparatus (200) decides to configure preconfigured gaps/NCSG, the network apparatus (200) releases at least one of the configured gaps and modifies one of the configured gaps or adds a new gap with pre-configuration indication/NCSG indication set as true. FIG. 9 depicts the network apparatus (200) handling gap and NCSG capabilities.

On a handover from the network apparatus (200) supporting measurement gap enhancement features (concurrent gaps/preconfigured gaps/NCSG) to another network apparatus (200), which does not support any of the measurement gap enhancement features, the network apparatus (200) does a full configuration rather than a delta configuration. With the full configuration, the network apparatus (200) provides all the need parameters to the UE (100). With the delta configuration, the network apparatus (200) provides a few parameters to the UE (100) and the UE (100) applies the remaining parameters based on its current configuration.

Handling of needForGaps and needForGapNCSG between the network apparatus supporting and not supporting needForGaps: On handover from the network apparatus (200) which has received needforgapnesg from the UE (gNB1) to the network apparatus (200) which does not support needforgapNCSG (gNB2), the source network apparatus (200) converts the needforGapNCSG to needforGaps and included in HO Request message. Alternatively, the source network apparatus (200) does not include needforgapNCSG received and the target network apparatus (200) requests needForGaps in the RRC Reconfiguration message for handover. The UE (100) reports the gap requirements (needForGaps) in RRC Reconfiguration Complete message.

Configuration of NCSG and gaps: The network apparatus (200) receives needforGapNCSG from the UE (100), with the needforGapNCSG informing that the UE (100) supports NCSG for certain bands and gaps for certain bands. On configuring the UE (100) an MO for a NR frequency which needs NCSG for measurements, the network apparatus (200) configures the UE (100) with NCSG. When the network apparatus (200) decides to configure the UE (100) with an MO for a NR frequency which needs gap for measurements and the UE (100) doesn't support NCSG and measurement gaps together as indicated through UE capability or the 3gpp release supported by the UE (100), the network apparatus (200) releases the NCSG and configures one or more gaps for measuring both the frequencies.

Requirement on maximum number of simultaneous configured MG patterns: If the UE (100) sends location measurement indication to inform that it needs gaps, when the network already has configured per-FR1 gap or a per-FR2 gap, the network apparatus (200) allocates a per-UE gap. In an embodiment, the network apparatus (200) associates the per-UE gap only to the PRS and no per-FR1 or per-FR2 measurements.

In an embodiment, the network apparatus (200) associates the per-UE gap allocated after receiving location measurement indication for starting measurements to other FR1 or FR2 or Inter-RAT measurement. Further on receiving another location measurement indication for stopping measurements, the network apparatus (200) performs the below actions based on the gaps configured.

1 per-FR1 (gap1) and 1 per-UE gap (gap2): If there are no FR2 frequencies associated to the per-UE gap, the network apparatus (200) reconfigures the per-UE gap to the per-FR1 gap and maps the FR1/LTE frequencies previously associated to the per-UE gap to per-FR1 gap. In an option, the network apparatus (200) releases the per-UE gap and adds the per-FR1 gap. Alternatively, the network apparatus (200) releases the per-UE gap and associates the FR1 or inter-RAT frequencies to the per-FR1 gap. If there are FR2 frequencies associated with per-UE gap and there are no per-FR1 or LTE frequencies associated to the per-UE gap, the network apparatus (200) reconfigures the per-UE to the per-FR2 gap and maps the FR2 frequencies previously associated to per-UE gap to the per-FR2 gap. If there are both FR1/LTE frequencies and FR2 frequencies associated to per-UE gap and the gap2, the network apparatus (200) releases the per-UE gap, associates FR1 frequencies to the per-FR1 gap and adds the per-FR2 gap and associates all FR2 frequencies to the new per-FR2 gap. The network apparatus (200) reconfigures the per-UE gap to the per-FR2 gap and associates FR1/LTE frequencies to the per-FR1 gap and associates all FR2 frequencies to the per-FR2 gap. The network apparatus (200) releases the per-FR1 gap (gap1) and adds the new per-UE gap associating the frequencies previously associated to the per-FR1 gap. The network apparatus (200) may just reconfigure gap1 to per-UE gap type instead of releasing per-FR1 gap and adding per-UE gap.

1 per-FR2 gap (gap1) and 1 per-UE gap (gap2); If there are no FR1/LTE frequencies associated to the per-UE gap, the network apparatus (200) reconfigures the per-UE gap to a per-FR2 gap and maps the FR2 frequencies previously associated to the per-UE gap to per-FR2 gap. In an option, the network apparatus (200) releases the per-UE gap and adds the per-FR2 gap. Alternatively, the network apparatus (200) releases per-UE gap and associates the FR2 to the existing per-FR2 gap (gap1). If there are FR1/LTE frequencies associated with per-UE gap and there are no FR2 frequencies associated to per-UE gap. The network apparatus (200) reconfigures per-UE to a per-FR1 gap and gaps the FR1 frequencies previously associated to per-UE gap to the per-FR1 gap. If there are both FR1/LTE frequencies and FR2 frequencies associated to per-UE gap and the gap2.

The network apparatus (200) releases the per-UE gap, associates FR2 frequencies to per-FR2 gap and adds the per-FR1 gap and associates all FR1/LTE frequencies to the new per-FR1gap. The network apparatus (200) reconfigures the per-UE gap to the per-FR1 gap and associates the FR1/LTE frequencies to per-FR1 gap and associates all FR2 frequencies to the per-FR2 gap. The network apparatus (200) releases the per-FR2 gap (gap1) and adds a new per-UE gap associating the frequencies previously associated to the per-FR2 gap. The network apparatus (200) may just reconfigure the gap1 to per-UE gap type instead of releasing per-FR2 gap and adding per-UE gap.

1 per-FR1 (gap1), 1 per-FR2 gap (gap2) and 1 per-UE gap (gap3): The network apparatus (200) associates the frequencies associated to gap3 between per-FR1 gap and per-FR2 gap. The network apparatus (200) may also reconfigure gap1 and gap2 to change gap repetition, periodicity, start and offset. The network apparatus (200) may create a new per-UE gap and map the FR1/LTE frequencies mapped to the per-FR1 gap and the FR2 frequencies mapped to the per-FR2 gap to the new per-UE gap and releases both per-FR1 gap gap1 and per-FR2 gap gap2. The network apparatus (200) releases the per-FR1 and per-FR2 gaps (gap1 and gap2) and associates all the frequencies mapped to gap1 and gap2 to the per-UE gap gap3.

FIG. 2 shows various hardware components of the UE (100), according to the embodiments as disclosed herein. In an embodiment, the UE (100) includes a processor (110), a communicator (120), a memory (130) and a measurement gap controller (140). The processor (110) is coupled with the communicator (120), the memory (130) and the measurement gap controller (140).

The measurement gap controller (140) receives a request for reporting a UE capability from the network apparatus (200). Based on the received request, the measurement gap controller (140) sends a message (e.g., RRC message) to the network apparatus (200). The message includes at least one of the UE capability information indicating the capability of supporting the preconfigured gap and the concurrent gap together, the capability of supporting NCSG and the concurrent gap together, the capability of the supporting NCSG and the non-NCSG measurement gap together, whether the UE (100) is capable of supporting the preconfigured NCSG, and whether the UE (100) is capable of supporting the concurrent gap, the preconfigured gap, and the preconfigured NCSG together.

The measurement gap controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

FIG. 3 shows various hardware components of the network apparatus (200), according to the embodiments as disclosed herein. In an embodiment, the network apparatus (200) includes a processor (210), a communicator (220), a memory (230) and a measurement gap controller (240). The processor (210) is coupled with the communicator (220), the memory (230) and the measurement gap controller (240).

The measurement gap controller (240) receives the message (e.g., RRC message or the like) from the UE (100). The message includes the UE capability information indicating the capability of supporting the preconfigured gap and the concurrent gap together, the capability of supporting NCSG and the concurrent gap together, the capability of the supporting NCSG and the non-NCSG measurement gap together, whether the UE (100) is capable of supporting the preconfigured NCSG, and whether the UE (100) is capable of supporting the concurrent gap, the preconfigured gap, and the preconfigured NCSG together.

In an embodiment, the measurement gap controller (240) modifies the already configured preconfigured gap to always active gap or releases the already configured preconfigured gap during a configuration of the concurrent gap when the UE (100) is already configured with the preconfigured gap and the UE (100) does not support the preconfigured gap and the concurrent gaps together. Further, the measurement gap controller (240) adds the always active gap.

In an embodiment, during the configuration of the concurrent gap when the UE (100) is already configured with the NCG and the UE (100) does not support the NCSG and the concurrent gaps together then, measurement gap controller (240) modifies an already configured NCSG to a measurement gap and releases the already configured NCG. Further, the measurement gap controller (240) adds the measurement gap.

In an embodiment, the measurement gap controller (240) receives the gap and the NCSG requirements through a needforgapNCSG from the UE (100). Further, the measurement gap controller (240) determines a handover from the network apparatus to another network apparatus. Further, the measurement gap controller (240) converts the needforGapNCSG to needforGaps upon determining that the another network apparatus does not support the needforgapnesg. Further, the measurement gap controller (240) appends the needforGaps in a handover request message.

In an embodiment, the measurement gap controller (240) receives a needforGapNCSG from the UE (100). The needforGapNCSG indicates that the UE (100) supports the NCSG for the first set bands and gaps for the second set of bands. Further, the measurement gap controller (240) releases the NCSG and configures at least one gap for measuring both frequencies when the network apparatus (200) decides to configure the UE (100) with the MO for the NR frequency, the UE (100) needs gap for measurements and the UE (100) does not support the NCSG and measurement gaps together as indicated through the UE capability information.

In an embodiment, the measurement gap controller (240) allocates the per-UE gap upon receiving the location measurement indication to inform that the UE (100) needs gaps, and the network apparatus (200) has configured the per-FR1 gap or the per-FR2 gap and mapping the per-UE gap for location measurements. In another embodiment, the measurement gap controller (240) releases the per-UE gap after receiving location measurement indication for stopping measurements and re-associating any measurements objects associated on the per-UE gap to the per-FR gap.

The measurement gap controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (210) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (210) may include multiple cores and is configured to execute the instructions stored in the memory (230).

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 3 shows various hardware components of the network apparatus (200) but it is to be understood that other embodiments are not limited thereon. In other embodiments, the network apparatus (200) may include less or more number of components. Further, the labels or names of the components are used only for illustrative purpose and does not limit the scope of the invention. One or more components can be combined together to perform same or substantially similar function in the network apparatus (200).

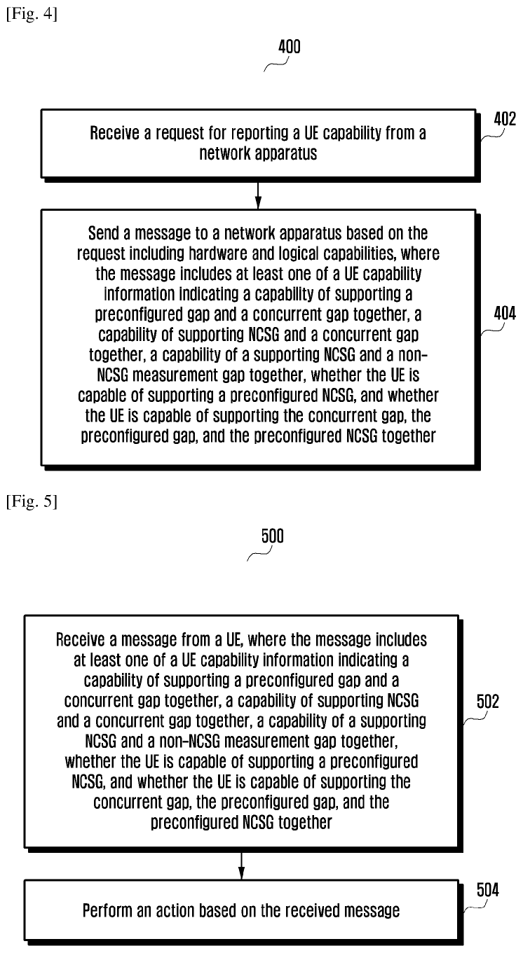

FIG. 4 is a flow chart (400) illustrating a method, implemented by the UE, for handling the measurement gap in the wireless network (1000), according to embodiments as disclosed herein. The operations (S402-S404) are handled by the measurement gap controller (140).

At step 402, the method includes receiving the request for reporting the UE capability from the network apparatus (200). At step 404, the method includes sending the message to the network apparatus (200) based on the received request including hardware and logical capabilities. The message includes at least one of the UE capability information indicating the capability of supporting the preconfigured gap and the concurrent gap together, the capability of supporting NCSG and the concurrent gap together, the capability of the supporting NCSG and the non-NCSG measurement gap together, whether the UE (100) is capable of supporting the preconfigured NCSG, and whether the UE (100) is capable of supporting the concurrent gap, the preconfigured gap, and the preconfigured NCSG together.

FIG. 5 is a flow chart (500) illustrating a method, implemented by the network apparatus (200), for handling the measurement gap in the wireless network (1000), according to embodiments as disclosed herein. The operations (S502-S504) are handled by the measurement gap controller (240).

At 502, the method includes receiving the message from the UE (100). The message includes at least one of the UE capability information indicating the capability of supporting the preconfigured gap and the concurrent gap together, the capability of supporting NCSG and the concurrent gap together, the capability of the supporting NCSG and the non-NCSG measurement gap together, whether the UE (100) is capable of supporting a preconfigured NCSG, and whether the UE (100) is capable of supporting the concurrent gap, the preconfigured gap, and the preconfigured NCSG together. At 504, the method includes performing the action based on the received message.

In an embodiment, the action corresponds to configure the concurrent gap when the UE (100) is already configured with the preconfigured gap and the UE (100) does not support the preconfigured gap and the concurrent gaps together. Further, the action corresponds modify the already configured preconfigured gap to always active gap or releases the already configured preconfigured gap. Further, the action corresponds to add the always active gap.

In an embodiment, the action corresponds to determine to release the configured gap upon determining that the UE (100) is configured with the concurrent gap and the UE (100) does not support the preconfigured gap or the NCSG and concurrent gaps together, when the network apparatus (200) determines to configure the preconfigured gaps or the NCSG. Further, the action corresponds to modify the configured gaps. Further, the action corresponds to add the new gap with the pre-configuration indication or the NCSG indication.

In an embodiment, the action corresponds to receive the gap and the NCSG requirements through the needforgapNCSG from the UE (100). Further, the action corresponds to determine the handover from the network apparatus (200) to another network apparatus. Further, the action corresponds to convert the needforGapNCSG to needforGaps upon determining that the another network apparatus does not support the needforgapnesg. Further, the action corresponds to append the needforGaps in the handover request message.

In an embodiment, the action corresponds to receive the needforGapNCSG from the UE (100). The needforGapNCSG indicates that the UE (100) supports the NCSG for the first set bands and gaps for the second set of bands. Further, the action corresponds to release the NCSG and configures at least one gap for measuring both frequencies when the network apparatus (200) decides to configure the UE (100) with the MO for the NR frequency, the UE (100) needs gap for measurements and the UE (100) does not support the NCSG and measurement gaps together as indicated through the UE capability information.

In an embodiment, the action corresponds to allocate the per-UE gap upon receiving the location measurement indication to inform that the UE (100) needs gaps, and the network apparatus (200) has configured the per-FR1 gap or the per-FR2 gap and mapping the per-UE gap for location measurements. In an embodiment, the action corresponds to release the per-UE gap after receiving location measurement indication for stopping measurements and re-associating any measurements objects associated on the per-UE gap to the per-FR gap.

FIG. 6 is a flow chart (800) illustrating an example method, implemented by the UE, for setting the default gap priority at the UE (100), according to embodiments as disclosed herein. The operations (602-604) are handled by the measurement gap controller (140).

At step 602, the method includes receiving the measurement gap configuration without gap priority. At step 604, the method includes setting the gap priority for the gap configured without gap priority to the value in the possible range excluding lowest value or highest value for gap priority i.e. set default gap priority to one from {2,3,4,5,6,7,8,9,10,11,12,13,14,15}.

FIG. 7 is a flow chart (700) illustrating an example method depicting the SN allocating measurement gaps when the MN/SN supports MGE in the wireless network (1000), according to embodiments as disclosed herein. The operations (702-704) are handled by the measurement gap controller (140).

At step 702, the method includes allocating per-FR2 measurement gap when at least one of the MN or the SN supports measurement gap enhancements. At step 704, the method includes sending the allocated measurement gap configuration to the MN in the CGConfig.

FIG. 8 is a flow chart (800) illustrating an example method, implemented by the network apparatus (200), for allocating multiple measurement gaps in the wireless network (1000), according to embodiments as disclosed herein.

At step 802, the method includes configuring the UE (100) to measure multiple frequencies where SMTC windows don't overlap using a single non-concurrent measurement gap. At step 804, the method includes configuring the concurrent measurement gaps to measure frequencies without overlapping SMTC windows.

FIG. 9 is a flow chart (900) illustrating an example method, implemented by the network apparatus (200), for handling gap and NCSG capabilities in the wireless network (1000), according to embodiments as disclosed herein. The operations (902-908) are handled by the measurement gap controller (240).

At step 902, the method includes receiving the gap and NCSG requirements (i.e., NeedForGapNCSG). The Freq F1 needs gaps and the Freq F2 needs NCSG. At step 904, the method includes configuring the measurements on frequency F2. The method includes configuring the NCSG to measure F2 through the RRC Reconfiguration message. At step 906, the method includes triggering to configure the measurements on the Freq F2. At step 908, the method includes configuring the measurements on the Freq F1. The method includes releasing the NCSG configured to measure F2. The method includes configuring one or more measurement gaps (non NCSG) to measure F1 and F2 through the RRC reconfiguration message.

The various actions, acts, blocks, steps, or the like in the flow charts (300-900) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1.-15. (canceled)

16. A method performed by a network apparatus for handling a measurement gap in a wireless network, comprising:
receiving, from a user equipment (UE), a capability information message including information for indicating whether the UE supports a multiple measurement gap;
identifying measurement gap configuration for the UE, based on the capability information message; and
performing at least one operation based on the identification,
wherein the measurement gap configuration includes at least one of first measurement gap configuration including at least one of a preconfigured gap or a network controlled small gap (NCSG) or second measurement gap configuration configured without the preconfigured gap and the NCSG.

17. The method of claim 16, wherein, in case that the measurement gap configuration is already configured with the preconfigured gap and the UE does not support the preconfigured gap and a concurrent gaps, performing the at least one operation comprises one of:
modifying the already configured preconfigured gap to always active gap: or
releasing the already configured preconfigured gap and adding at least one always active gap.

18. The method of claim 16, wherein, in case that the measurement gap configuration is already configured with the NCSG and the UE does not support the NCSG and a concurrent gaps, performing the at least one operation comprises one of:
modifying an already configured NCSG to a measurement gap;
releasing the already configured NCSG: or
adding at least one measurement gap.

19. The method of claim 16, wherein performing the at least one operation comprises:
receiving, from the UE, a needforGapNCSG, wherein the needforGapNCSG indicates that the UE supports the NCSG for a first set bands and gaps for a second set of bands; and
releasing the NCSG and configuring at least one gap for measuring both frequencies when the network apparatus decides to configure the UE with a measurement object (MO) for a new radio (NR) frequency, the UE needs the at least one gap for measurements, and the UE does not support the NCSG and measurement gaps as indicated through a UE capability information.

20. The method of claim 16, wherein performing the at least one operation comprises one of:
allocating a per-UE gap upon receiving a location measurement indication to inform that the UE needs gaps, and the network apparatus has configured a per-FR1 gap or a per-FR2 gap and mapping the per-UE gap for location measurements;
releasing the per-UE gap after receiving the location measurement indication for stopping measurements and re-associating any measurements objects associated on the per-UE gap to a per-FR gap: or
receiving, from the UE, gap and NCSG requirements through a needforgapNCSG, determining a handover from the network apparatus to another network apparatus, converting the needforGapNCSG to needforGaps upon determining that the another network apparatus does not support the needforgapncsg, and appending the needforGaps in a handover request message.

21. A network apparatus for handling a measurement gap in a wireless network, the network apparatus comprising:
a processor; and
a memory;
wherein the processor is configured to:
receive, from a user equipment (UE), a capability information message including information for indicating whether the UE supports a multiple measurement gap,
identify measurement gap configuration for the UE, based on the capability information message, and
perform at least one operation based on the identification, and
wherein the measurement gap configuration includes at least one of first measurement gap configuration including at least one of a preconfigured gap or a network controlled small gap (NCSG) or second measurement gap configuration configured without the preconfigured gap and the NCSG.

22. The network apparatus of claim 21, wherein, in case that the measurement gap configuration is already configured with the preconfigured gap and the UE does not support the preconfigured gap and a concurrent gaps, the at least one operation comprises one of:
modifying the already configured preconfigured gap to always active gap, or
releasing the already configured preconfigured gap and adding at least one always active gap.

23. The network apparatus of claim 21, wherein, in case that the measurement gap configuration is already configured with the NCSG and the UE does not support the NCSG and a concurrent gaps, the at least one operation comprises one of:
modifying an already configured NCSG to a measurement gap,
releasing the already configured NCSG, or
adding at least one measurement gap.

24. The network apparatus of claim 21, wherein the at least one operation comprises:
receiving, from the UE, a needforGapNCSG, wherein the needforGapNCSG indicates that the UE supports the NCSG for a first set bands and gaps for a second set of bands, and
releasing the NCSG and configuring at least one gap for measuring both frequencies when the network apparatus decides to configure the UE with a measurement object (MO) for a new radio (NR) frequency, the UE needs the at least one gap for measurements, and the UE does not support the NCSG and measurement gaps as indicated through a UE capability information.

25. The network apparatus of claim 21, wherein the at least one operation comprises one of:
allocating a per-UE gap upon receiving a location measurement indication to inform that the UE needs gaps, and the network apparatus has configured a per-FR1 gap or a per-FR2 gap and mapping the per-UE gap for location measurements,
releasing the per-UE gap after receiving the location measurement indication for stopping measurements and re-associating any measurements objects associated on the per-UE gap to a per-FR gap, or
receiving, from the UE, gap and NCSG requirements through needforgapNCSG, determining a handover from the network apparatus to another network apparatus, converting the needforGapNCSG to needforGaps upon determining that the another network apparatus does not support the needforgapncsg, and appending the needforGaps in a handover request message.
